(19) United States
(12) Patent Application Publication
(10) Pub. No.: US 2015/0081467 A1
(43) Pub. Date: Mar. 19, 2015

(54) USER-DRIVEN REVERSE AUCTIONS SYSTEMS AND METHODS

(71) Applicant: Bank of America Corporation, Charlotte, NC (US)

(72) Inventors: David M. Grigg, Rock Hill, SC (US); Raja Bose, Charlotte, NC (US); Matthew A. Calman, Charlotte, NC (US); Alicia C. Jones, Fort Mill, SC (US); Carrie Anne Hanson, Charlotte, NC (US); Elizabeth S. Votaw, Potomac, MD (US)

(21) Appl. No.: 14/550,253

(22) Filed: Nov. 21, 2014

Related U.S. Application Data
(63) Continuation of application No. 13/213,922, filed on Aug. 19, 2011.

(51) Int. Cl. G06Q 30/08

(52) U.S. Cl. CPC G06Q 30/08
USPC 705/26.3

(57) ABSTRACT

Systems and methods for providing user-driven reverse auctions are provided. The systems and methods enable a user to request bids for products or services, receive bids in response to the offers, and manage the bids. The methods provide receiving, at a computing device, a request from a user for an offer for products or services, the request including search criteria; identifying, via the computing device, at least one merchant of said products or services based on the search criteria; sending the request to the at least one merchant and receiving one or more bids from the at least one merchant; and presenting, via a computing device, the one or more bids to the user.

### CROSS-REFERENCE TO RELATED APPLICATIONS

This application is filed under the provisions of 35 U.S.C. §120 and is a continuation of U.S. patent application Ser. No. 13/213,922, filed Aug. 19, 2011, and entitled “User-Driven Reverse Auctions Systems and Methods” in the name of David M. Grigg, which is assigned to the assignee hereof and hereby expressly incorporated by reference herein.

### BACKGROUND

Consumers that are pressed for time often make quick decisions when making purchases. Busy travelers, for example, must quickly decide on where to buy food or pick up reading material. Businesses may not have the opportunity to attract or provide targeted offers to hurried consumers. In the rush to make purchases, consumers often make miss good deals, better product variety, and the like.

For all these reasons and others, there is a need for improved systems and methods for requesting offers and receiving targeted bids for business conveniently and easily using a reverse auction process.

### BRIEF SUMMARY

Embodiments of the present invention address these and/or other needs by providing innovative system and methods for user-driven reverse auctions. Advantageously, embodiments of the invention include systems and methods for user-driven reverse auctions.

In the embodiments of the invention, a method to set up a reverse auction for products or services desired by a user is provided. The method includes receiving, at a computing device, a request from a user for an offer for products or services, the request comprising search criteria; identifying, via the computing device, at least one merchant of said products or services based on the search criteria; sending the request for the offer to the at least one merchant and receiving one or more bids from the at least one merchant; and presenting, via a computing device, the one or more bids to the user. In some embodiments, the one or more bids comprises a first bid and a second bid, and wherein the first bid comprises a first price and the second bid comprises a second price, wherein the second price is lower than the first price. In other embodiments of the method, the at least one merchant comprises a first merchant associated with the first bid and a second merchant associated with the second bid and the one or more bid comprises a discount price on said products or services.

In some embodiments of the method, the search criteria comprises: transaction data associated with the user, where the transaction data includes one of a purchase, a time period of a transaction, a product associated with a transaction, or a purchase amount; and a geographical location associated with the user. In some embodiments, the one or more bids are associated with one or more business locations. The method further comprises ranking the one or more bids based on the proximity of the one or more business locations to a geographical location associated with the user. In some embodiments, the search criteria comprise behavior data associated with the user.

In some embodiments of the method, the one or more bids are associated with a product, the method further comprising grouping the one or more bids into sub-categories based on the product. The method, in some embodiments, further comprising: receiving user-defined preferences; filtering the one or more bids based on the user-defined preferences to produce filtered bids; and presenting the filtered bids to the user. The method further comprising: receiving user-defined preferences; and filtering the at least one merchant based on the user-defined preferences.

In some embodiments, the method further comprises processing a transaction associated with the one or more bids. In other embodiments, the method further comprises identifying a reward offer based on the transaction; and presenting the reward offer to the user. In still other embodiments, the reward offer comprises a coupon.

In accordance with embodiments of the invention, a computer program product for a reverse auction for products or services desired by a user is provided. The computer program product comprising a computer-readable medium having computer-executable instructions for performing: receiving, at a computing device, a request from a user for an offer for products or services, the request comprising search criteria; identifying, via the computing device, at least one merchant of said products or services based on the search criteria; sending the request for the offer to the at least one merchant and receiving one or more bids from the at least one merchant; and presenting, via a computing device, the one or more bids to the user.

The computer-executable instructions, in some embodiments, further perform: receiving transaction data associated with the user; and identifying the at least one merchant based on the transaction data. In some embodiments, the one or more bids comprises a first bid and a second bid, wherein the first bid is different from the second bid; or a first bid and a second bid, wherein the first bid is the same as the second bid. In other embodiments, the computer-executable instructions further perform: receiving user-defined preferences from the user, the preferences comprising a second user; and communicating the one or more bids to the second user.

In some embodiments of the computer program product, the one or more bids comprise a price and/or a rebate. In some embodiments, the computer-executable instructions further perform: receiving transaction data and/or behavior data associated with the user; filtering the transaction data and/or behavior data to produce filtered data; and presenting the guidelines to the merchants based on the filtered data. In some embodiments, the guidelines comprise a bid and/or a geographical location.

The computer-executable instructions, in some embodiments, further perform: receiving user-defined preferences; comparing the user-defined preferences and the one or more bids; and determining that the one or more bids do not match the user-defined preferences. The computer-executable instructions, in some embodiments, further perform: searching for the at least one merchant based on the search criteria; determining a modification to the search criteria; and identifying the at least one merchant based on the modification. In some embodiments, the search criteria comprise a price range and/or a geographical location. In some embodiments, the computer-executable instructions further perform: presenting suggestions for additional search criteria to the user.

In accordance with embodiments of the invention, a system for a reverse auction for products or services desired by a user is provided. The system comprising: a computer apparatus including a processor and a memory; and a mobile auction system module stored in the memory, executable by the processor and configured to receive a request from a user for an offer for products or services, the request comprising search criteria; identify at least one merchant of said products or services based on the search criteria; send the request for the offer to the at least one merchant and receive one or more bids from the at least one merchant; and present the one or more bids to the user.

In some embodiments, the processor is further configured to receive transaction data associated with the user, and identify the at least one merchant based on the transaction data; receive user-defined preferences comprising a geographic location; and rank the one or more bids based on the geographic location; and/or receive updates associated with the one or more bids from the at least one merchant; and present the updates to the user in real time.

In some embodiments of the system, the one or more bids comprises a first bid comprising a first discount and a second bid comprising a second discount, wherein the second discount is higher than the first discount. In other embodiments, the search criteria comprise a product and/or a business. In still other embodiments, the bid comprises a price for the product or service, and/or a location.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1B provide flowcharts of a system and method for user-driven reverse auctions, in accordance with example embodiments of the invention;

FIG. 2 provides a block diagram illustrating a mobile auction system and environment, in accordance with embodiments of the invention;

FIG. 3 provides a block diagram illustration the user's mobile device of FIG. 2, in accordance with embodiments of the invention;

FIG. 4 provides a block diagram illustrating the merchant's computing device of FIG. 2, in accordance with embodiments of the invention;

FIG. 5 provides a block diagram illustrating the auctions system of FIG. 2, in accordance with embodiments of the invention;

FIGS. 6A-6B provide flow charts illustrating a process for user-driven reverse auctions, in accordance with embodiments of the invention;

FIGS. 7A-7D provide screenshots of a graphical user interface used during a process for user-driven reverse auctions, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, assets management firms, insurance companies and the like.

Embodiments of the present invention provide a system and method for user-driven reverse auctions. Embodiments of the invention allow users to request offers for specific products and services, receive bids in response to the request, and track the status of the bids using user-driven reverse auctions. Embodiments of the invention also allow users to set up search criteria for the bids and submit preferences for filtering and organizing the bids.

The embodiments described herein may refer to use of a transaction or transaction event to trigger the location of the user and/or the user's mobile device. In various embodiments, occurrence of a transaction also triggers the sending of information such as offers and the like. Unless specifically limited by the context, a “transaction” refers to any communication between the user and the financial institution or other entity monitoring the user's activities. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

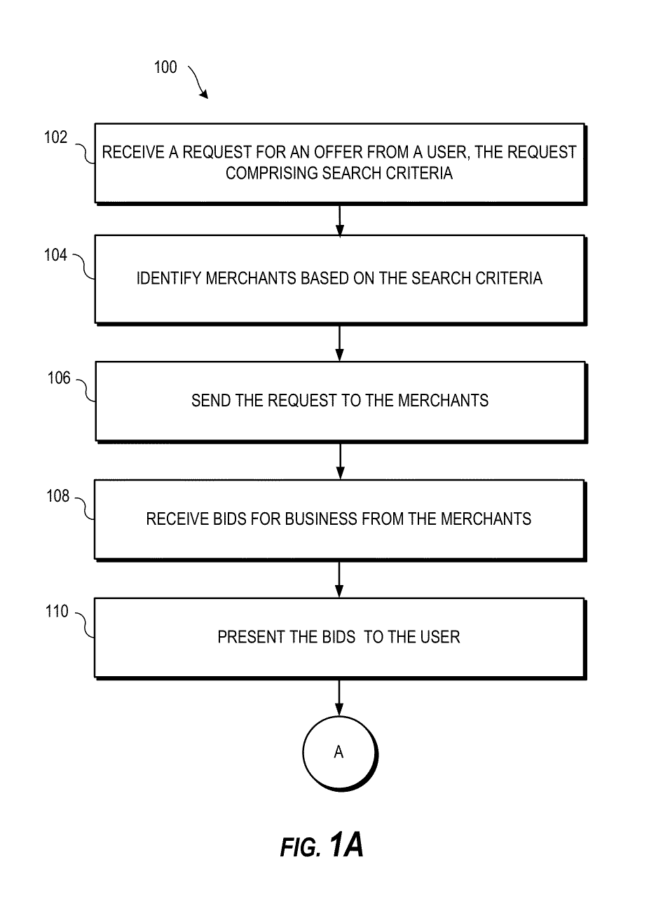

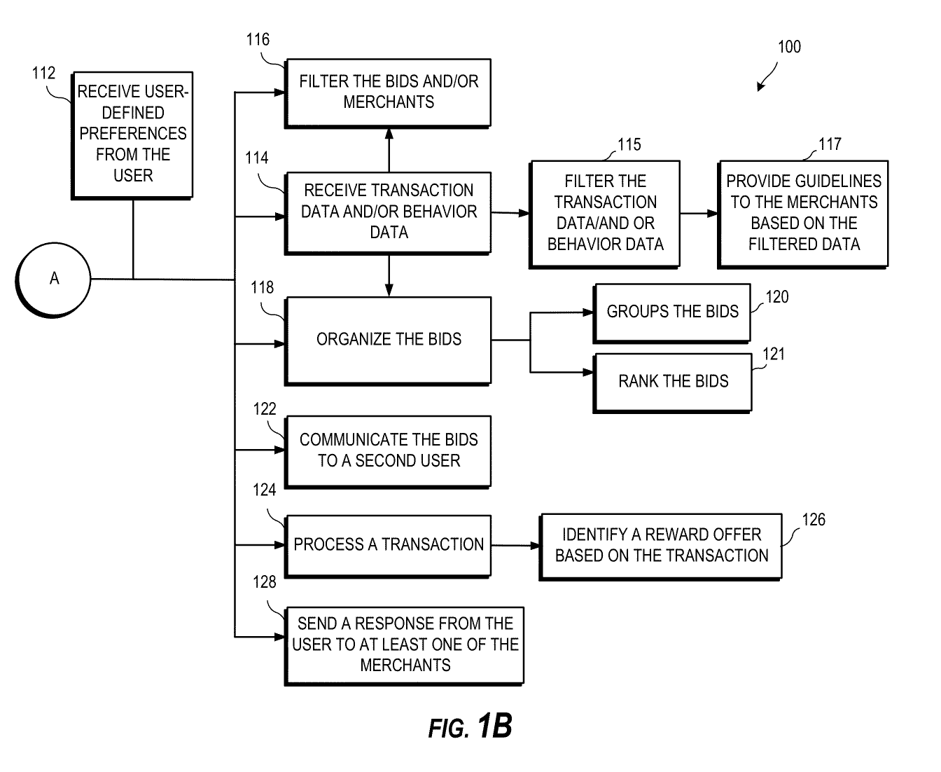

FIG. 1A is a flowchart providing an overview of a system and method 100 for user-driven reverse auctions, in accordance with one or more embodiments of the invention. The blocks in the flowchart represent various steps of the embodiments of the invention. It will be understood that one or more devices, such as one or more mobile device and/or one or more other computing devices and/or servers, can be configured to perform one or more steps of the method 100. In some embodiments, the one or more devices performing the steps are associated with a financial institution. In other embodiments, the one or more devices performing the steps are associated with a business, third party, and/or user. It will be further understood that steps of the processes described herein may be performed in orders different than those illustrated in the flowcharts.

In block 102, a step in which a request for an offer is received, the request comprising search criteria, is represented. In some embodiments, the offer is for products or services. The search criteria include any information for finding an offer. Examples of the search criteria include a geographic location associated with the user or mobile device and/or user, a product or service, a type of offer (e.g., discount, free product, rebate, etc.), a merchant, time period for receiving bids, price range, transaction history associated with a user, and the like. For example, the user using a mobile device can set the location of the mobile device using a GPS service or data associated with an accelerometer in the search criteria, and can also include a search term such as “food” and a subcategory of food such as “bakery.” The search criteria may include the present geographical location of the user, or any other geographical location. For example, the geographical location may include a location the user will be traveling to in the near future or the current location of the user.

In block 104, a step in which a plurality of merchants is identified based on the search criteria is represented. The merchants include businesses, one or more branches of a franchise, an online business, and the like. In some embodiments, the merchants are identified based on a single search criterion and/or a plurality of search criteria. For example, the merchants may include a franchise included in the search criteria. As another example, the merchants may be identified based on category of products such as clothing, a geographical location, time period, and a price range. In some embodiments, the merchants are identified based on a rule, a calculation, an algorithm, or any type of formula for eliminating subsets of data from a data pool based on specified criteria. For example, the merchant may be identified based on one or more transactions associated with the user. A particular business may be identified based on a user's previous purchases at that particular business. The identified merchants may also be filtered based on transaction data, behavior data, and/or user-defined preferences to narrow the number of merchants receiving the request or the number of bids as described in more detail below.

In other embodiments, the merchants are identified based on any number of searches using the search criteria. For example, the search results for the merchants can be narrowed as described in more detail below.

In block 106, the step in which the request is sent to the merchants is represented. It will be understood that in some embodiments the request is sent to a third party. For example, the request may be sent to an aggregator or go-between entity who then forwards and disperses the request to the identified merchants. And as represented in block 108, one or more bids for business are received from the merchants in response to the request. Typically, the merchants submit one or more bids to compete for the user's business. In some embodiments, the one or more bids comprise a named price, discount, and/or reward for a product or service. For example, in some embodiments, the bids include a price or price range, free products or services, discounts, coupons, rebates, gift cards, reward points, and the like. Additionally, the bids may include a description of the proposed products or services, expiration date of the bid, time period for accepting the bid, locations associated with the bids, terms and conditions, and the like. In other embodiments, the bids include updated bids received from the merchants. For example, a merchant may submit a bid and resubmit an updated bid at a lower price.

In block 110, the step in which the bid is presented to the user is represented. It will be understood that the bids can be viewed by the merchants and the user in real time. In this way, the merchants participating in the user-driven reverse auctions can update their bids in response to competitive bids. And the user is able to review each bid to determine the best deal. For example, one merchant may submit a bid that includes a price offer or a discount, and another merchant may submit a bid that matches the previous bid, or that includes a lower price or a higher discount. In some embodiments, the bids are organized. For example, the bids may be filtered and/or grouped and presented to the user as described in more detail below with regard to FIG. 1B. It will be understood that the reverse auction bidding process may occur for any length of time. For example, the bidding process may occur over the course of a few minutes if the user is interested in an immediate bid or a few months if the user is interested in a future bid. The user, for example, may want to use a bid on a vacation occurring in the future and may be presented with bids in anticipation of the vacation.

Referring now to FIG. 1B, the method 100 is further illustrated in accordance with embodiments of the invention. As represented by block 112, user-defined preferences are received from the user. The preferences include criteria for filtering the bids and/or merchants, organizing the bids, communicating the bids to a second user, and processing the transaction, all of which are described below. As represented by block 114, transaction data and/or behavior data is received. In some embodiments, the transaction data is received from the user. For example, the user may include past transaction or a transaction history in the user-defined preferences. In other embodiments, the transaction data is received from the merchants. The transaction data includes a transaction history associated with the user, purchases associated or unassociated with the bids, online purchases, point of transaction device purchases, purchases associated with the merchants, rebate transactions, reward transactions, an account balance check, a rewards transfer, an account money transfer, a mobile banking application transaction, an “e-wallet” transaction, or any other transaction associated with the user, as well as a time period associated with a transaction, the frequency of a transaction, a purchase amount, a product associated with a transaction, purchase methods, and the like as described herein. In some embodiments, the search criteria include the transaction data and/or behavior data.

Behavior data includes data associated with the user. The behavior data includes transactions associated with a reward that is associated or unassociated with a bid; shopping habits of the user, and the like. Examples of the behavior data include transactions associated with a reward, purchases made using a reward, location and time stamp associated with use of a reward, frequency of transactions associated with a reward, details of the reward, the number of rewards received and the number of rewards utilized, and the like. For example, the behavior data may include whether or not a user has used a particular reward in the past and the details associated with the reward. The behavior data may indicate, for example, that the user only uses coupons at businesses located within a ten mile radius of the user's domicile. The behavior data may further include, for example, the time of day and the day of the week a user is likely to shop at a particular business or store.

In block 115, the step in which the transaction data/and or behavior data are filtered to produced filtered data is represented. For example, the data may be filtered to pinpoint past transactions made using a reward associated with a particular merchant, type of product, reward amount, location, and the like. As represented by block 117, guidelines are provided to the merchants based on the filtered data. It will be understood that the step represented by block 117 may occur at any time. For example, the step represented by block 117 may occur before or simultaneously with the step in which the requests are sent to the merchant (block 106). Examples of the guidelines include bid criteria, a threshold for a bid amount, locations for using a bid, type of products to include in the bid, a bid amount, time period to use the bid, and/or other restrictions or suggestions. The guidelines may be suggestive or mandatory in nature. For example, the guidelines may restrict the bids to include only certain select products or the guidelines may simply suggest that only certain types of products be included in the bids. The guidelines, in some embodiments, include an enhanced customer profile. For example, the enhanced customer profile may include information that shows that the user has never used a coupon that was less than a 20% discount, or that the user only uses coupons at stores located in a particular area. In this way, the guidelines enable the merchant to make an informed decision when determining the bids to optimize the user's experience.

In block 116, the step in which the bids and/or merchants are filtered is represented. For example, bids may be filtered based on a price range, a particular product, or the like. In some embodiments, the bids and/or merchants are filtered based on the transaction data, behavior data, and/or user-defined preferences. In some embodiments, the bids are filtered based on a rule, formula, or algorithm. For example, an engine filters the bids based on an algorithm that includes certain data such as a price amount, geographical coordinates, a discount amount, and the like. In some embodiments, the user-defined preferences are compared to the one or more bids. In other embodiments, a determination is made that the one or more bids do not match the user-defined preferences. For example, the user-defined preferences may include a specific product that is not available in a particular zip code. As a result, the user may receive a message stating that no bids match the user-defined preferences for narrowing the bids. In still other embodiments, a determination is made to modify the search criteria. For example, if a merchant or bid cannot be identified based on the search criteria, a modification to the search criteria may be determined for the merchant or bid based on the modification. In such cases, the user may be notified that the search criteria were expanded to include additional search criteria. If the number of merchants or bids are over a certain number (e.g. a very large number such as 100), the user may be asked to modify the search criteria to narrow the results.

As represented by block 118, the bids are organized by grouping the bids or by ranking the bids, as shown in block 120 and 121 respectively. In some embodiments, the bids are organized based on the user-defined preferences and/or transaction data. For example, if a user frequents a particular nail salon, that nail salon may be placed first on a list of bids presented to the user. The bids, in some embodiments, are ranked based on geographical location. The bids, for example, closest to a geographical location associated with a user or user's mobile device may be ranked higher than bids farther away. In some embodiments, the user defines the distance from the geographical location to rank and/or filter bids. The bids located over 20 miles away may be filtered out and the bids ranked according to the proximity to the specified geographical location. In other embodiments, the bids are ranked based on a time associated with the bid. For example, the last submitted bid may be listed first or last on the list bids depending on the user's preference. As another example, if a user receives bids from a large number of different merchants, the bids may be grouped into categories or sub-categories. For example, if a request for car service returns bids for oil changes, tire rotations, and air conditioner checkups, the different sub-categories of car services can be grouped together to make it easier for the user to review the bids and make a selection.

In block 122, the step in which the bids are communicated to a second user is represented. For example, a user may want to invite friends or family to join them at a particular restaurant, and may input a preference that enables the user to forward the bids to friends. The bids may be automatically communicated to the second user, or the bids may be communicated on a case by case basis. In some embodiments, the bids are communication to a second user associated with a social network. For example, the bids may be forwarded to the social network accounts of the user's friends based on the user-defined preferences.

In block 124, the step in which a transaction is processed is represented. In some embodiments, a transaction associated with the bids is processed. For example, a user may retrieve a coupon using a mobile device by presenting a display of the coupon at a point of transaction device when making a purchase or by inputting a coupon code when purchasing online. As represented block 126, a reward offer is identified based on the transaction. The reward offer includes coupons, discounts, free products or services, rewards points, rebates, and the like. If the user, for example, uses a bid that includes a coupon to make a shoe purchase, another coupon for shoes may be presented to the user based on the shoe purchase.

In block 128, the step in which a response from the user is sent to at least one the merchants is represented. The response includes communications related to the bid or merchant. Examples of the response include an acceptance of the bid, a rejection of the bid, and/or a modification of the bid. The modification of the bid may include additional terms and conditions or a modification of the terms and conditions, an adjustment of the proposed bid amount (e.g., an increase in a discount percent), a modification of the products or services in the bid, and the like. A communication from the merchant, in some embodiments, is sent to the user in reply to the response from the user. In this way, the merchant and the user may communicate back and forth in order to facilitate agreement between the two parties. In some embodiments, a contract is sent to the user and/or the merchants. The user may communicate with the merchant via an application on the user's mobile device, email, text, and the like.

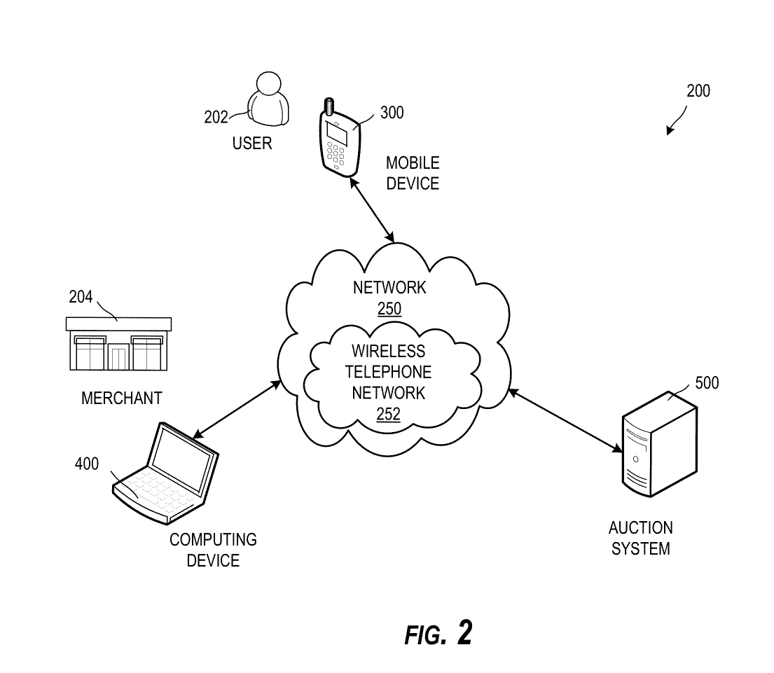

FIG. 2 provides a block diagram illustrating a mobile auction system and environment 200, in accordance with an embodiment of the invention. As illustrated in FIG. 2, the user-driven auction environment 200 includes a user 202 and a merchant 204. A user of the system may be a person, a customer of a business, a person associated with a store, or any other entity capable of using user-driven reverse auctions as described herein. The merchant of the system is any business or organization (e.g., a franchise) associated with one or more business locations.

The environment 200 also includes a mobile device 300 for the user 202 and a computing device 400 for the merchant 204. The computing device 400 may be any device that employs a processor and memory and can perform computing functions, such as a personal computer or a mobile device. As used herein, a “mobile device” 300 is any mobile communication device, such as a cellular telecommunications device (i.e., a cell phone or mobile phone), personal digital assistant (PDA), a mobile Internet accessing device, or other mobile device.

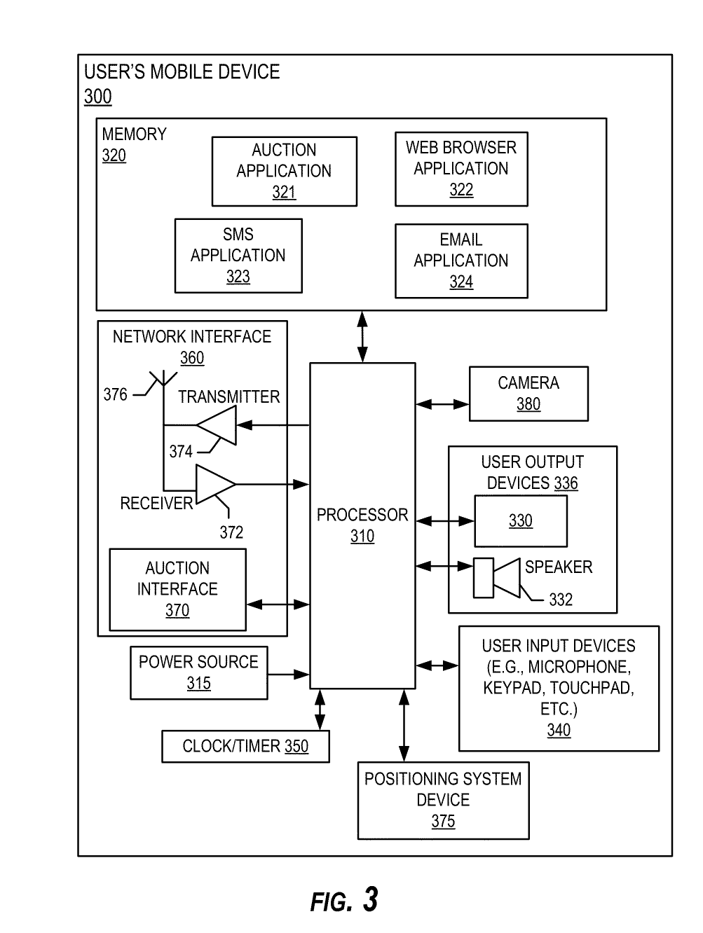

The mobile device 300 and computing device 400 are configured to communicate over a network 250 with a mobile auction system 500. The user's mobile device 300, the mobile auction system 500, and the merchant's computing device 400 are each described in greater detail below with reference to FIGS. 3-5. The network 250 may include a local area network (LAN), a wide area network (WAN), and/or a global area network (GAN). The network 250 may provide for wireline, wireless, or a combination of wireline and wireless communication between devices in the network. In one embodiment, the network 250 includes the Internet. In one embodiment, the network 250 includes a wireless telephone network 252.

In general, a mobile device 300 is configured to connect with the network 250 to log the user 202 into a mobile auction system 500. The mobile auction system 500 involves authentication of a user in order to access the user's account on the auction system 500. For example, the mobile auction system 500 is a system where the user 202 logs into his/her account such that the user 202 or other entity can access data that is associated with the user 202. For example, in one embodiment of the invention, the mobile system 500 is a mobile auction system maintained by a financial institution. In such an embodiment, the user 202 can use the mobile device 300 to log into the mobile auction system to access the user's auction account. Logging into the mobile auction system 500 generally requires that the user 202 authenticate his/her identity using a user name, a passcode, a cookie, a biometric identifier, a private key, a token, and/or another authentication mechanism that is provided by the user 202 to the mobile auction system 500 via the mobile device 300.

The auction system 500 is in network communication with other devices, such as the merchant's computing device 500. In one embodiment, the invention may provide an application download server such that software applications that support the mobile auction system 500 can be downloaded to the mobile device 300.

In some embodiments of the invention, the application download server is configured to be controlled and managed by one or more third-party data providers (not shown in FIG. 2) over the network 250. In other embodiments, the application download server is configured to be controlled and managed over the network 250 by the same entity that maintains the mobile auction system 500.

FIG. 3 provides a block diagram illustrating the consumer mobile device 300 of FIG. 2 in more detail, in accordance with embodiments of the invention. In one embodiment of the invention, the mobile device 300 is a mobile telephone. However, it should be understood, however, that a mobile telephone is merely illustrative of one type of mobile device 300 that may benefit from, employ, or otherwise be involved with embodiments of the present invention and, therefore, should not be taken to limit the scope of embodiments of the present invention. Other types of mobile devices 300 may include portable digital assistants (PDAs), pagers, mobile televisions, gaming devices, laptop computers, cameras, video recorders, audio/video player, radio, GPS devices, accelerometer devices, or any combination of the aforementioned.

The mobile device 300 generally includes a processor 310 communicably coupled to such devices as a memory 320, user output devices 336, user input devices 340, a network interface 360, a power source 315, a clock or other timer 350, a camera 380, and a positioning system device 375. The processor 310, and other processors described herein, generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 250. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. The signals may include signaling information in accordance with the air interface standard of the applicable cellular system of the wireless telephone network 252. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols, IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include an auction interface 370. The auction interface 370 may include software, such as encryption software, and hardware, such as a modem, for communicating information to and/or from one or more devices on the network 250. For example, the mobile device 300 may be configured so that it can be used as a credit or debit card by, for example, wirelessly communicating account numbers or other authentication information to a terminal of the network 250.

As described above, the mobile device 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the mobile device 300 to receive data from a user such as the user 202, may include any of a number of devices allowing the mobile device 300 to receive data from a user, such as a keypad, keyboard, touch-screen, touchpad, microphone, mouse, joystick, other pointer device, button, soft key, and/or other input device(s). The user interface may also include a camera 380, such as a digital camera.

The mobile device 300 may also include the positioning system device 375 that is configured to be used by a positioning system to determine a location of the mobile device 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate location of the mobile device 300. In other embodiments, the positioning system device 375 includes a proximity sensor or transmitter, such as an RFID tag, that can sense or be sensed by devices known to be located proximate a merchant or other location to determine that the consumer mobile device 300 is located proximate these known devices. In still other embodiments, the mobile device 300 includes an accelerometer device. The accelerometer device may be used to determine the location of the mobile device, including data that shows that the mobile device is moving and the direction of that movement.

The mobile device 300 further includes a power source 315, such as a battery, for powering various circuits and other devices that are used to operate the mobile device 300. Embodiments of the mobile device 300 may also include a clock or other timer 350 configured to determine and, in some cases, communicate actual or relative time to the processor 310 or one or more other devices.

The mobile device 300 also includes the memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile device 300 described herein. For example, the memory 320 may include such applications as a conventional web browser application 322, an email application 324, a short message service (SMS) application 323 for sending and receiving texts, and/or an auction system client application 321. These applications also typically provide a graphical user interface (GUI) on the display 330 that allows the user 202 to communicate with the consumer mobile device 300, the mobile auction system 500, and/or other devices or systems. In one embodiment of the invention, when the user 202 decides to enroll in the mobile auction program, the user 202 downloads or otherwise obtains the mobile auction system client application from the mobile auction system 500 or from a distinct application server. In other embodiments of the invention, the user 202 interacts with the mobile auction system 500 via the web browser application 322 in addition to, or instead of, the mobile auction system client application 321.

The memory 320 can also store any of a number of pieces of information, and data, used by the mobile device 300 and the applications and devices that make up the mobile device 300 or are in communication with the mobile device 300 to implement the functions of the mobile device 300 and/or the other systems described herein. For example, the memory 320 may include such data as user authentication information, etc.

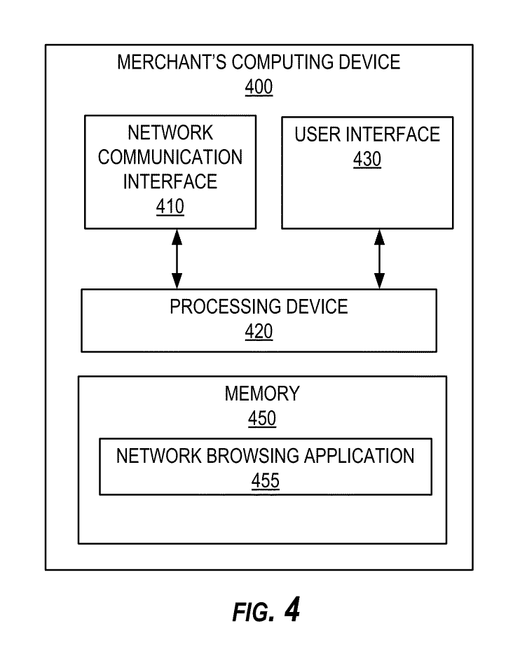

Referring now to FIG. 4, the computing device 400 associated with the merchant 204 also includes various features, such as a network communication interface 410, a processing device 420, a user interface 430, and a memory device 450. The network communication interface 410 includes a device that allows the computing device 400 to communication over the network 250 (shown in FIG. 2). In one embodiment, a network browsing application 455 provides for a user to establish network communication with a mobile auction system 500 (shown in FIG. 3) for the purpose of sending mobile bids and/or registering an auction account with the mobile auction system 500 and/or receiving responses to the bids, in accordance with embodiments of the invention.

As used herein, a “processing device,” such as the processing device 420, generally refers to a device or combination of devices having circuitry used for implementing the communication and/or logic functions of a particular system. For example, a processing device 420 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 420 may further include functionality to operate one or more software programs based on computer-executable program code thereof, which may be stored in a memory. As the phrase is used herein, a processing device 420 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein a “user interface” 430 generally includes a plurality of interface devices and/or software that allow an individual using the computing device 400 (e.g., the merchant) to input commands and data to direct the processing device to execute instructions. For example, the user interface 430 presented in FIG. 4 may include a graphical user interface (GUI) or an interface to input computer-executable instructions that direct the processing device 420 to carry out specific functions. The user interface 430 employs certain input and output devices to input data received from the mobile auction system 500 or output data to the mobile auction system 500 or the user 202. These input and output devices may include a display, mouse, keyboard, button, touchpad, touch screen, microphone, speaker, LED, light, joystick, switch, buzzer, bell, and/or customer input/output device for communicating with one or more customers.

As used herein, a “memory device” 450 generally refers to a device or combination of devices that store one or more forms of computer-readable media for storing data and/or computer-executable program code/instructions. Computer-readable media is defined in greater detail below. For example, in one embodiment, the memory device 450 includes any computer memory that provides an actual or virtual space to temporarily or permanently store data and/or commands provided to the processing device 420 when it carries out its functions described herein.

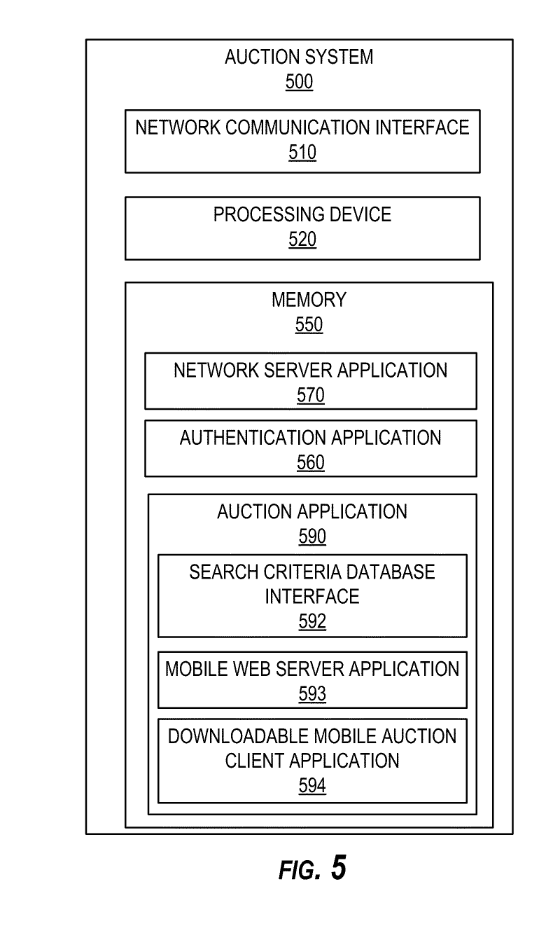

FIG. 5 provides a block diagram illustrating the mobile auction system 500 in greater detail, in accordance with an embodiment of the invention. As illustrated in FIG. 5, in one embodiment of the invention, the mobile auction system 500 includes a processing device 520 operatively coupled to a network communication interface 510 and a memory device 550. In certain embodiments, the mobile auction system 500 is operated by a first entity, such as a financial institution, while in other embodiments, the mobile auction system 500 is operated by an entity other than a financial institution.

It should be understood that the memory device 550 may include one or more databases or other data structures/repositories. The memory device 550 also includes computer-executable program code that instructs the processing device 520 to operate the network communication interface 510 to perform certain communication functions of the mobile auction system 500 described herein. For example, in one embodiment of the mobile auction system 500, the memory device 550 includes, but is not limited to, a network server application 570, an authentication application 560, a user account data repository (not shown) which includes user authentication data and user account information, a mobile auction application 590 which includes an search criteria database interface 592 for communicating with a search criteria database for storing the search criteria (not shown in the figures), a mobile web server application 593, a downloadable mobile auction system client application 594 and other computer-executable instructions or other data. The computer-executable program code of the network server application 570, the authentication application 560, or the mobile auction application 590 may instruct the processing device 520 to perform certain logic, data-processing, and data-storing functions of the mobile auction system 500 described herein, as well as communication functions of the mobile auction system 500.

As used herein, a “communication interface” generally includes a modem, server, transceiver, and/or other device for communicating with other devices on a network, and/or a user interface for communicating with one or more customers. Referring again to FIG. 5, the network communication interface 510 is a communication interface having one or more communication devices configured to communicate with one or more other devices on the network 250, such as the mobile device 300, the mobile auction system 500, the search criteria database (not shown), and the merchant's computing device 400. The processing device 520 is configured to use the network communication interface 510 to transmit and/or receive data and/or commands to and/or from the other devices connected to the network 250.

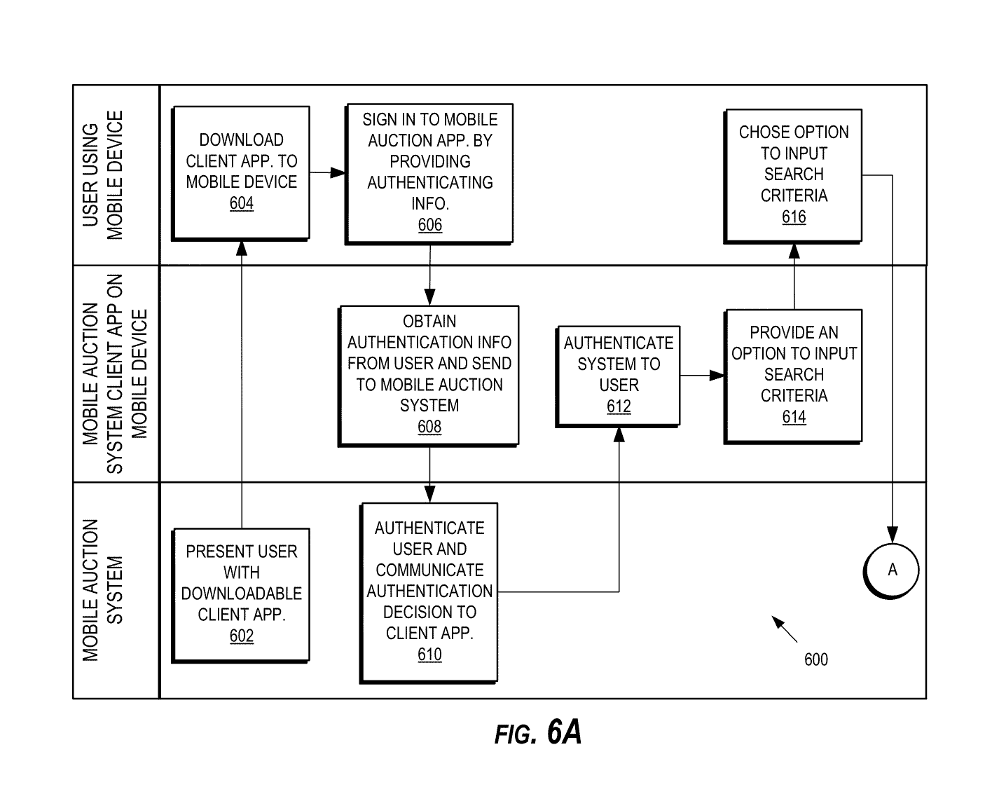

FIGS. 6A-6B provide flow charts illustrating a process 600 for an auction program using a mobile device, in accordance with an embodiment of the invention. FIGS. 6A-6B illustrate the flow chart in terms of “swim lanes” associated with entities which may perform the operations in each respective swim lane. The entities illustrated in the exemplary Figures are a mobile auction system, a user using a mobile device, and a merchant using a computing device. However, it should be noted that other entities could also be involved and some embodiments of the invention may not be limited to the three entities illustrated in FIGS. 6A-6B. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 602 of FIG. 6A where a mobile auction system 500 presents a user with a downloadable client application so that the user can participate in a mobile auction program. In some embodiments, the mobile auction system 500 presents the terms of the auction program that will govern the operation of the program. In some embodiments, the user can read the terms on the user's mobile device 300, whereas in other embodiments, the user can only read the terms on a personal computing device. In still other embodiments, the user accepts the terms of the auction service by activating an appropriate button on the mobile webpage. It will be understood that the user can accept the terms of the auctions service before the process step represented by block 602.

The next step in the process is illustrated in block 604 where the user 202 using mobile device 300 downloads the client application to the mobile device. In some embodiments, the user inputs registration information. For example, the user signs ups for an auction application by inputting an email address and/or name, street address, phone number(s), and the like. The user may also input a user name, password, security question and answer, or other authenticating information. In some embodiments, the mobile auction system 500 provides terms and conditions associated with the auction application.

The process then moves to the function illustrated by block 606 of FIG. 6A where the user 202 signs in to the mobile auction system 500 using the client application by providing appropriate authentication information. The next step in the process is illustrated in block 608 of FIG. 6A where the mobile auction system client application 594 on the mobile device 300 obtains authentication information from the user and sends the authentication information to the mobile auction system 500.

The next step in the process is illustrated in block 610 of FIG. 6A where the mobile auction system 500 authenticates the user 202 and communicates the authentication decision to the mobile auction system client application 594.

The next step in the process is illustrated in block 612 of FIG. 6A where the mobile auction system client application 594 authenticates the system to the user 202. In one embodiment of the invention, the authentication is achieved using a web-based security system that provides mutual authentication between end-users and websites. In a challenge-response process of security system, the user has to identify himself or herself on a secure website by entering a username. Subsequently, the website authenticates itself to the user by displaying an image and an accompanying phrase that the user had previously configured. If the user recognizes this image and the accompanying phrase, the user can authenticate himself or herself to the website by entering a password. Other embodiments of the invention may use other authentication systems.

The next step in the process is illustrated in block 614 of FIG. 6A where the mobile auction system client application 594 provides a mobile auction program menu including an option to input search criteria. The next step in the process is illustrated in block 616 of FIG. 6A where the user 202 selects the input search criteria option from the menu.

The next step in the process is illustrated in block 618 of FIG. 6B where the user 202 inputs the search criteria. The search criteria include geographical location, product or service, type of offer, and the like as described herein. The user may also input other information including a mobile number, an email address, contact information for a second user, user-defined preferences, and the like. In some embodiments, the search criteria is stored in a search criteria database (not shown).

The next step in the process is illustrated in block 620 of FIG. 6B where the mobile auction system 500 identifies a merchant or plurality of merchants. As described herein, the merchant is identified based on the search criteria. The next step in the process is illustrated in block 622 of FIG. 6B where the mobile auction system 500 sends the request to the merchant. The request may be sent by any means such as text or email. In some embodiments, the merchant downloads an auction system client application. Upon providing authentication information, for example, the merchant may receive the request. In other embodiments, the merchant receives the request directly from the user.

The next step in the process is illustrated in block 624 of FIG. 6B where the merchant 204 using the computing device 400 sends the bids to the mobile auction system 500. The bids include offers, such as a price offer or discount offer as described herein. The next step in the process is illustrated in block 626 of FIG. 6B where the mobile auction system 500 filters and/or organizes the bids. In some embodiments, the bids are grouped into categories or sub-categories. In other embodiments, the bids are ranked according to the search criteria (e.g., a geographical location).

The next step in the process is illustrated in block 628 of FIG. 6B where the mobile auction system client application 594 presents options to narrow the bids. In block 630, the user 202 inputs preferences. In some embodiments, the bids are filtered and/or organized based on the user-defined preferences. The next step in the process is illustrated in block 632 of FIG. 6B where the mobile auction system 500 presents the bids to the user. For example, the bids may be presented to the user 202 on the display of the mobile device 300 as a list that may be updated in real time. For example, if the merchant updates a bid or provides additional bids, the user 202 can view the bids as the updates take place.

The next step in the process is illustrated in block 634 of FIG. 6B where the mobile auction system client application 594 provides options to view the bids. The next step in the process is illustrated in block 636 of FIG. 6B where the user 202 views and selects the bids. In some embodiments, the user may edit the bids. For example, the user may delete a specific bid or all bids associated with a particular merchant or price range. The user may also, for example, save selected bids for later use.

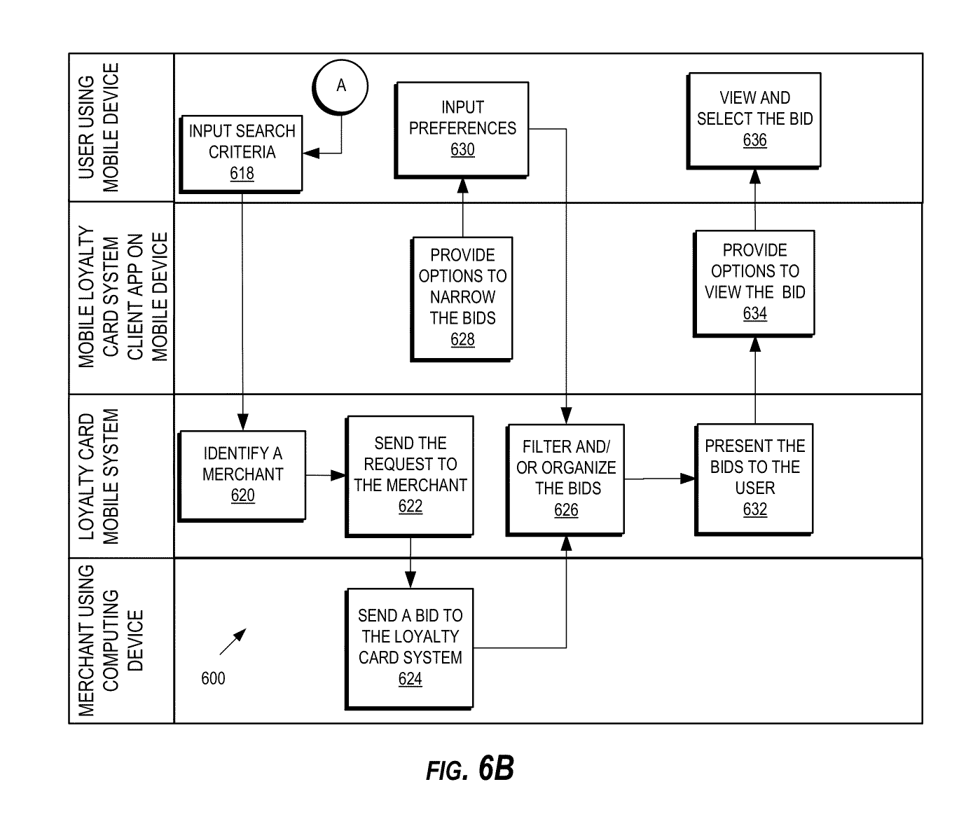

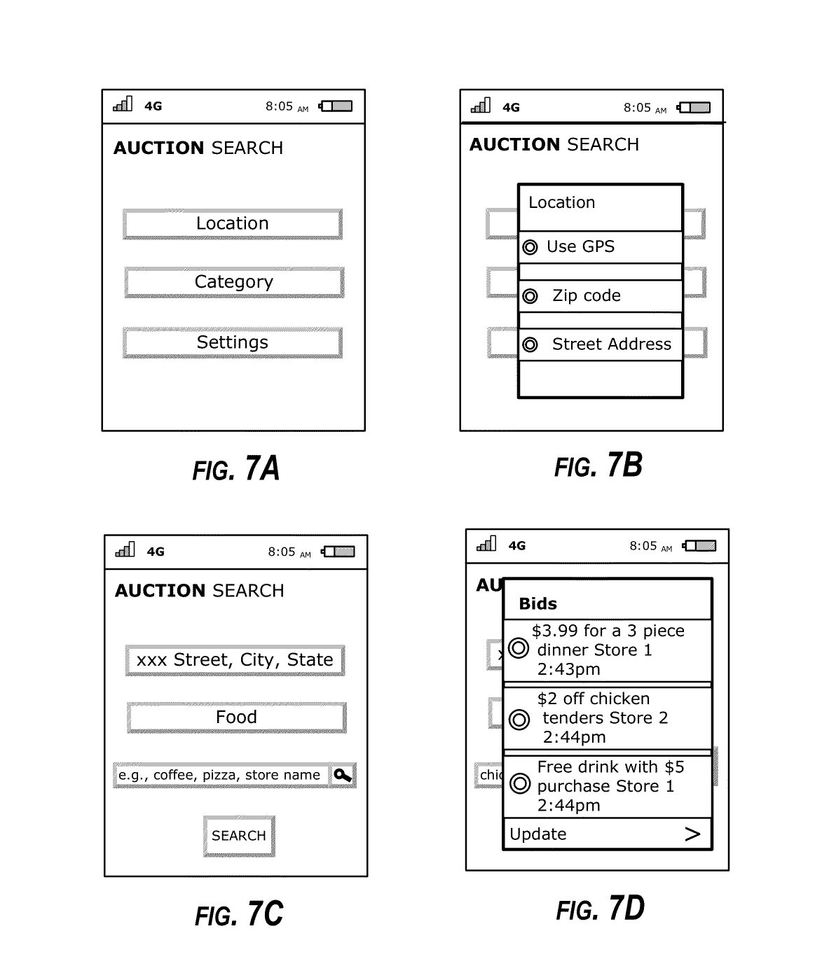

FIGS. 7A-7D illustrate screenshots of a graphical user interface used during a process for user-driven reverse auctions, in accordance with embodiments of the invention. In FIGS. 7A-7D, the screenshots are associated with a mobile device (e.g., the mobile device 300). FIG. 7A illustrates various buttons for inputting search criteria including a “Location” button, a “Category” button, and a “Settings” button. The settings buttons further include options (not shown) for inputting contact information, notification methods, user-defined preferences, and the like.

In FIG. 7B, a “pop-up” window appears when the Location button is selected. The “pop-up” window includes a GPS selection for determining the location of the mobile device, a field box for inputting a zip code, and a street address field box for inputting a desired address. In other embodiments, the location may be determined based on an accelerometer data associated with a mobile device. In some embodiments, the user may input more than one location.

In FIG. 7C, the location criteria field box is filled and includes a street address. The category field box is filled in and includes the category of “Food.” Also shown is a sub-category field box for inputting a sub-category of food such as coffee, pizza, or a store name of a merchant. Although only one category and sub-category field box are shown, it will be understood that the user may input any number of categories or sub-categories.

In FIG. 7D, the user inputs “chicken” (not shown) into the sub-category field box. The bids are displayed in a pop-up window as a list. The user may select one or more of the bids to use in a transaction or view more details about the bids. The pop-up window further includes an option to update the bids such that the user can view the bids as they are updated. The bids include the time the bid was posted by the merchant, the name of the merchant, a description of the product, and the price or discount associated with the product. The details of each bid (not shown) may include directions to the location of the merchant, the hours of operation for the location, expiration of the bid, a link to the website of the merchant, and the like. In some embodiments, the bids are presented on a map. For example, pinpoint icons may be used to indicate the locations of the bids or merchants associated with the bids on a particular map. The user may select one or more bids by clicking on the pinpoint icons. Additional information such as the distance from a particular geographical location, directions, street views, and the like may also be provided to the user. The pinpoint icons may also be color coded such that the user can easily identify a category of bids or merchants. For example, if the search criteria include “shoes” and “pizza,” the bids related to shoes may be in red and the bids related to pizza may be in yellow.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A computer-implemented method for setting up a reverse auction for a product or service desired by a user, the method comprising:
receiving, via the computing device processor, a request from a user for at least one merchant to provide a bid to offer a product or service to the user, wherein the request includes selection criteria comprising a maximum distance from a geographic location of the user for the bid, the product or service desired by the user, a maximum price for the product or service, and an expiration time for receiving the bid;
determining, via the computing device processor, the geographic location of the user and a time at which the request was created in relation to the expiration time;
receiving a transaction history of the user comprising previous purchases made by the user;
determining, via the computing device processor, at least one merchant based on the maximum distance from the geographic location of the user for the bid and the transaction history of the user, wherein the at least one merchant is determined based on the user having conducted a previous transaction at the least one merchant;
sending, via the computing device processor, the request for the bid to the at least one merchant;
receiving one or more bids from the at least one merchant;
filtering, via the computing device processor, the one or more bids based at least in part on the maximum price for the product or service and the expiration time for receiving the bid; and
presenting, via the computing device processor, the filtered one or more bids to the user.

2. The computer-implemented method of claim 1, wherein the one or more bids comprise a first bid and a second bid, and wherein the first bid comprises a first price and the second bid comprises a second price, wherein the second price is lower than the first price.

3. The computer-implemented method of claim 1, wherein the method further comprises:
communicating a notice that none of the one or more bids meet the maximum price for the product or service and the expiration time for receiving the bid; and
presenting an option to the user to submit an maximum price.

4. The computer-implemented method of claim 1, the method further comprising ranking the one or more filtered bids based on proximity to the user.

5. The computer-implemented method of claim 1, wherein the method further comprises grouping the one or more filtered bids into sub-categories based on the product or service offered by the one or more merchants.

6. The computer-implemented method of claim 1, wherein the method further comprises processing a transaction associated with the one or more bids.

7. The computer-implemented method of claim 1, wherein the method further comprises:
identifying a reward offer associated with the one or more bids based on the transaction history of the user; and
presenting the reward offer to the user.

8. A computer program product for setting up a reverse auction for a product or service desired by a user, the computer program product comprising at least one non-transitory computer-readable medium having computer-readable program code portions embodied therein, the computer-readable program code portions comprising:
an executable portion for receiving a request from a user for at least one merchant to provide a bid to offer a product or service to the user, wherein the request includes selection criteria comprising a maximum distance from a geographic location of the user for the bid, the product or service desired by the user, a maximum price for the product or service, and an expiration time for receiving the bid;
an executable portion for determining the geographic location of the user and a time at which the request was created in relation to the expiration time;
an executable portion for receiving a transaction history of the user comprising previous purchases made by the user;
an executable portion for determining, via the computing device processor, at least one merchant based on the maximum distance from the geographic location of the user for the bid and the transaction history of the user, wherein the at least one merchant is determined based on the user having conducted a previous transaction at the least one merchant;
an executable portion for sending the request for the bid to the at least one merchant;
an executable portion for receiving one or more bids from the at least one merchant;
an executable portion for filtering the one or more bids based at least in part on the maximum price for the product or service and the expiration time for receiving the bid; and
an executable portion for presenting the filtered one or more bids to the user.

9. The computer program product of claim 8, wherein the one or more filtered bids comprise a first bid and a second bid, and wherein the first bid comprises a first price and the second bid comprises a second price, wherein the second price is lower than the first price.

10. The computer program product of claim 8, wherein the computer-readable program code portions further comprises:
an executable portion for communicating a notice that none of the one or more bids meet the maximum price for the product or service and the expiration time for receiving the bid; and
an executable portion for presenting an option to the user to submit an maximum price.

11. The computer program product of claim 8, wherein the computer-readable program code portions further comprises an executable portion for ranking the one or more filtered bids based on proximity to the user.

12. The computer program product of claim 8, wherein the computer-readable program code portions further comprises an executable portion for grouping the one or more filtered bids into sub-categories based on the product or service offered by the one or more merchants.

13. The computer program product of claim 8, wherein the computer-readable program code portions further comprises an executable portion for processing a transaction associated with the one or more bids.

14. The computer program product of claim 8, wherein the computer-readable program code portions further comprises:
an executable portion for identifying a reward offer associated with the one or more bids based on the transaction history of the user; and
an executable portion for presenting the reward offer to the user.

15. A system for a reverse auction for setting up a reverse auction for a product or service desired by a user, the system comprising:
a non-transitory storage device;
a communication device;
one or more processing devices operatively coupled to the storage device and the communication device;
at least one module stored in said storage device and comprising instruction code that is executable by the one or more processors and configured to cause said one or more processors to:
receive a request from a user for at least one merchant to provide a bid to offer a product or service to the user, wherein the request includes selection criteria comprising a maximum distance from a geographic location of the user for the bid, the product or service desired by the user, a maximum price for the product or service, and an expiration time for receiving the bid;
determine the geographic location of the user and a time at which the request was created in relation to the expiration time;
receive a transaction history of the user comprising previous purchases made by the user;
determine at least one merchant based on the maximum distance from the geographic location of the user for the bid and the transaction history of the user, wherein the at least one merchant is determined based on the user having conducted a previous transaction at the least one merchant;
send the request for the bid to the at least one merchant;
receive one or more bids from the at least one merchant;
filter the one or more bids based at least in part on the maximum price for the product or service and the expiration time for receiving the bid; and
present the filtered one or more bids to the user.

16. The system of claim 15, wherein the one or more bids comprises a first bid and a second bid, and wherein the first bid comprises a first price and the second bid comprises a second price, wherein the second price is lower than the first price.

17. The system of claim 15, wherein said module further comprises instruction code for causing said one or more processors to:
communicate a notice that none of the one or more bids meet the maximum price for the product or service and the expiration time for receiving the bid; and
present an option to the user to submit an maximum price.

18. The system of claim 15, wherein said module further comprises instruction code for causing said one or more processors to rank the one or more filtered bids based on proximity to the user.

19. The system of claim 15, wherein said module further comprises instruction code for causing said one or more processors to group the one or more filtered bids into sub-categories based on the product or service offered by the one or more merchants.

20. The system of claim 15, wherein said module further comprises instruction code for causing said one or more processors to process a transaction associated with the one or more bids.
